(19) United States
(12) Patent Application Publication
(10) Pub. No.: US 2006/0199620 A1
(43) Pub. Date: Sep. 7, 2006

(54) Method, apparatus and system for power transmission

(75) Inventors: Charles E. Greene, Pittsburgh, PA (US); John G. Shearer, Ligonier, PA (US); Daniel W. Harrist, Carnegie, PA (US)

Correspondence Address: Ansel M. Schwartz;Attorney at Law, Suite 304, 201 N. Craig Street, Pittsburgh, PA, 15213, US

(73) Assignee: Firefly Power Technologies, Inc.

(21) Appl. No.: 11/356,892

(22) Filed: Feb. 16, 2006

Related U.S. Application Data
(60) Provisional application No. 60/656,165, filed on Feb. 24, 2005.

(51) Int. Cl. H04B 1/04; H04B 1/38

(52) U.S. Cl. 455/572; 455/127.1

(57) ABSTRACT

A transmitter for transmitting power to a receiver to power a load, where the receiver does not have a DC-DC converter. The transmitter comprises a pulse generator for producing pulses of power. The transmitter comprises an antenna in communication with the pulse generator through which the pulses are transmitted from the transmitter. A system for power transmission which transmits only pulses of power without any data. A method for transmitting power to a receiver to power a load. An apparatus for transmitting power to a receiver to power a load comprises a plurality of transmitters, each of which produce pulses of power which are received by the receiver to power the load. A system for power transmission which receives pulses of power transmitted by the power transmitter to power a load but does not use the pulses as a clock signal.

### FIELD OF THE INVENTION

The present invention relates to the transmission of power to a receiver to power a load, where the receiver preferably does not have a DC-DC converter. More specifically, the present invention relates to the transmission of power to a receiver to power a load, where the power is transmitted in pulses and where the receiver preferably does not have a DC-DC converter, or where the pulses of power are transmitted without any data, or where the receiver does not use the pulses as a clock to run a DC-DC converter.

### BACKGROUND OF THE INVENTION

Current methods of Radio Frequency (RF) power transmission use a Continuous Wave (CW) system. This means the transmitter continuously supplies a fixed amount of power to a remote unit (antenna, rectifier, device). However, the rectifier has an efficiency that is proportional to the power received by the antenna. To combat this problem, a new method of power transmission was developed that involves pulsing the transmitted power (On-Off Keying (OOK) the carrier frequency).

### SUMMARY OF THE INVENTION

The present invention pertains to a transmitter for transmitting power to a receiver to power a load, where the receiver does not have a DC-DC converter. The transmitter comprises a pulse generator for producing pulses of power. The transmitter comprises an antenna in communication with the pulse generator through which the pulses are transmitted from the transmitter.

The present invention pertains to a system for power transmission. The system comprises a transmitter which transmits only pulses of power without any data. The system comprises a receiver which receives the pulses of power transmitted by the power transmitter to power a load.

The present invention pertains to a method for transmitting power to a receiver to power a load. The method comprises the steps of producing pulses of power with a pulse generator. There is the step of transmitting the pulses through an antenna in communication with the pulse generator to the receiver to power the load.

The present invention pertains to a method for transmitting power. The method comprises the steps of transmitting pulses of power with a transmitter. The method comprises the step of receiving the pulses of power transmitted by the power transmitter with a receiver to power a load. The receiver has a rectifier whose efficiency is increased as compared to a corresponding continuous wave power transmission system by receiving the pulses of power.

The present invention pertains to an apparatus for transmitting power to a receiver to power a load. The apparatus comprises a plurality of transmitters, each of which produce pulses of power which are received by the receiver to power the load.

The present invention pertains to a method for transmitting power to a receiver to power a load. The method comprises the steps of producing pulses of power from an apparatus having a plurality of transmitters which are received by the receiver to power the load.

The present invention pertains to a system for power transmission. The system comprises a transmitter which transmits pulses of power. The system comprises a receiver which receives the pulses of power transmitted by the power transmitter to power a load but does not use the pulses as a clock signal.

The present invention pertains to a system for power transmission. The system comprises means for transmitting pulses of power. The system comprises means for receiving the pulses of power transmitted by the transmitting means to power a load but does not use the pulses for a clock signal.

The present invention pertains to a transmitter for transmitting power to a receiver to power a load, where the receiver does not have a DC-DC converter. The transmitter comprises means for producing pulses of power. The transmitter comprises an antenna in communication with the pulse generator through which the pulses are transmitted from the transmitter.

### BRIEF DESCRIPTION OF THE DRAWINGS

In the accompanying drawings, the preferred embodiment of the invention and preferred methods of practicing the invention are illustrated in which:

FIG. 1 is a pictorial explanation of pulse transmission of the present invention.

FIG. 2 is a block diagram of the transmission system.

FIG. 3 is an example of pulse transmission.

FIG. 3a is a block diagram of a receiver.

FIGS. 4a and 4b show multiple transmitters, single frequency, and multiple timeslots.

FIG. 5 shows multiple transmitters, multiple frequencies and no timeslots.

FIGS. 6a and 6b show a single transmitter, single frequency and non-return to zero (NRZ).

FIGS. 7a and 7b show a single transmitter, multiple frequencies and multiple timeslots.

FIGS. 8a and 8b show multiple transmitters, single frequency and multiple timeslots.

FIGS. 9a and 9b show single transmitter, multiple frequencies, multiple timeslots and NRZ.

FIGS. 10a and 10b show single transmitter, multiple frequencies, multiple timeslots and return to zero (RZ).

FIG. 11 shows multiple transmitters, multiple frequencies, no timeslots and varied amplitude.

FIGS. 12a and 12b show multiple transmitters, multiple frequencies, multiple timeslots and varied amplitude.

FIG. 13 is a block diagram of a receiver including data extracting apparatus.

### DETAILED DESCRIPTION

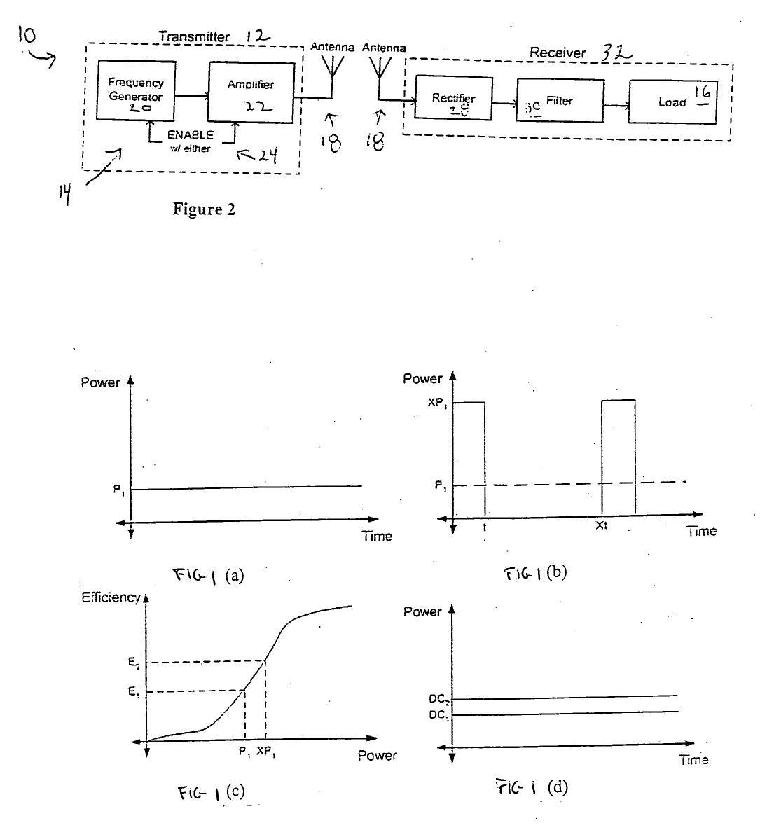

Referring now to the drawings wherein like reference numerals refer to similar or identical parts throughout the several views, and more specifically to FIG. 2 thereof, there is shown a transmitter 12 for transmitting power to a receiver 32 to power a load 16, where the receiver 32 does not have a DC-DC converter 36. The transmitter 12 comprises a pulse generator 14 for producing pulses of power. The transmitter 12 comprises an antenna 18 in communication with the pulse generator 14 through which the pulses are transmitted from the transmitter 12.

Preferably, the pulse generator 14 includes a frequency generator 20 having an output, and an amplifier 22 in communication with the frequency generator 20 and the antenna 18.

The transmitter 12 preferably includes an enabler 24 which controls the frequency generator 20 or the amplifier 22 to form the pulses. Preferably, the enabler 24 defines a time duration between pulses as a function of a transmitting frequency of the pulses. The time duration is preferably greater than one-half of one cycle of the frequency generator 20 output. Preferably, the power of the transmitted pulses is equivalent to an average power of a continuous wave power transmission system 10. The average power Pavg of the pulses is preferably determined by

$${P}_{AVG} = \frac{{P}_{PEAK} ( {T}_{PULSE} )}{{T}_{PERIOD}} .$$

The pulses can be transmitted in any ISM band or in an FM radio band.

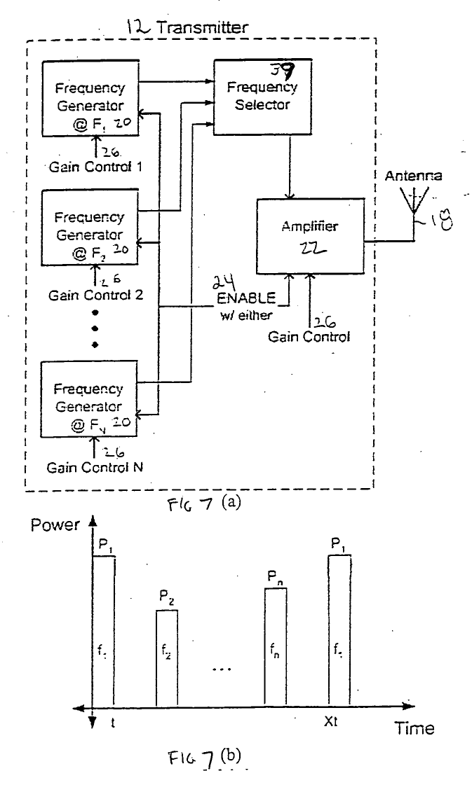

Alternatively, the pulse generator 14 produces a continuous amount of power between pulses, or the pulse generator 14 produces pulses at different output frequencies sequentially, as shown in FIGS. 7a and 7b, or at different amplitudes. In the latter, preferably the pulse generator 14 includes a plurality of frequency generators 20; an amplifier 22; and a frequency selector 39 in communication with the frequency generators 20 and the amplifier 22, that determines and routes the correct frequency from the frequency generators 20 to the amplifier 22.

Alternatively, the pulse generator 14 transmits data between the pulses or the pulse generator 14 transmits data in the pulses, or both.

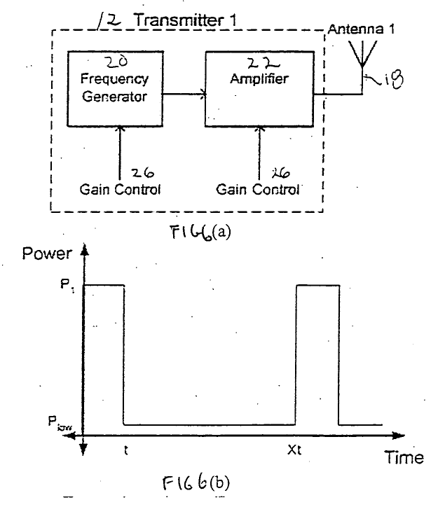

Alternatively, the transmitter 12 includes a gain control 26 which controls the frequency generator 20 or the amplifier 22 to form the pulses, as shown in FIG. 6a. Preferably, the gain control 26 defines a time duration between pulses as a function of a transmitting frequency of the pulses.

The present invention pertains to a system 10 for power transmission, as shown in FIG. 2. The system 10 comprises a transmitter 12 which transmits only pulses of power without any data. The system 10 comprises a receiver 32 which receives the pulses of power transmitted by the power transmitter 12 to power a load 16.

Preferably, the receiver 32 includes a rectifier 28. The rectifier 28 efficiency is preferably increased by over 5 percent as compared to a corresponding continuous wave power transmission system 10 by receiving the pulses of power. Preferably, the rectifier 28 efficiency is increased by over 100 percent as compared to a corresponding continuous wave power transmission system 10.

The present invention pertains to a method for transmitting power to a receiver 32 to power a load 16. The method comprises the steps of producing pulses of power with a pulse generator 14. There is the step of transmitting the pulses through an antenna 18 in communication with the pulse generator 14 to the receiver 32 to power the load 16.

The present invention pertains to a method for transmitting power. The method comprises the steps of transmitting pulses of power with a transmitter 12. The method comprises the step of receiving the pulses of power transmitted by the power transmitter 12 with a receiver 32 to power a load 16. The receiver 32 has a rectifier 28 whose efficiency is increased as compared to a corresponding continuous wave power transmission system 10 by receiving the pulses of power.

The present invention pertains to an apparatus for transmitting power to a receiver 32 to power a load 16. The apparatus comprises a plurality of transmitters 12, each of which produce pulses of power which are received by the receiver 32 to power the load 16, as shown in FIG. 6a.

Preferably, the apparatus includes a controller in communication with each transmitter 12. Each transmitter 12 is assigned an associated time slot by the controller so that only one pulse from the plurality of transmitters 12 is transmitted at a given time. The apparatus preferably includes a plurality of time slot selectors. Each transmitter 12 is in communication with a corresponding time slot selector of the plurality of time slot selectors. The controller issues a control signal to each selector which activates the corresponding transmitter 12 for its assigned time slot.

The present invention pertains to a method for transmitting power to a receiver 32 to power a load 16. The method comprises the steps of producing pulses of power from an apparatus having a plurality of transmitters 12 which are received by the receiver 32 to power the load 16.

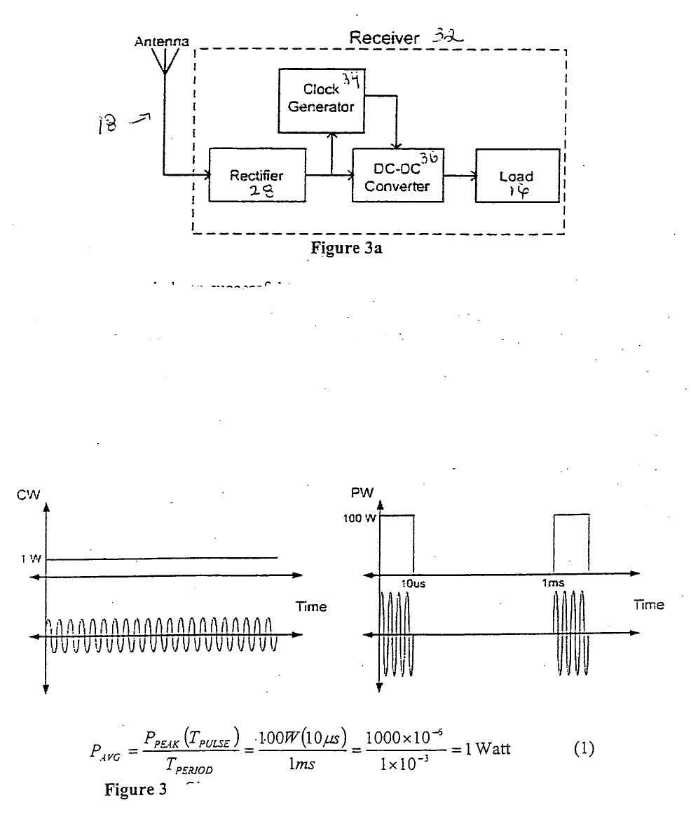

The present invention pertains to a system 10 for power transmission. The system 10 comprises a transmitter 12 which transmits pulses of power. The system 10 comprises a receiver 32 which receives the pulses of power transmitted by the power transmitter 12 to power a load 16 but does not use the pulses as a clock 34 signal, as shown in FIG. 3b.

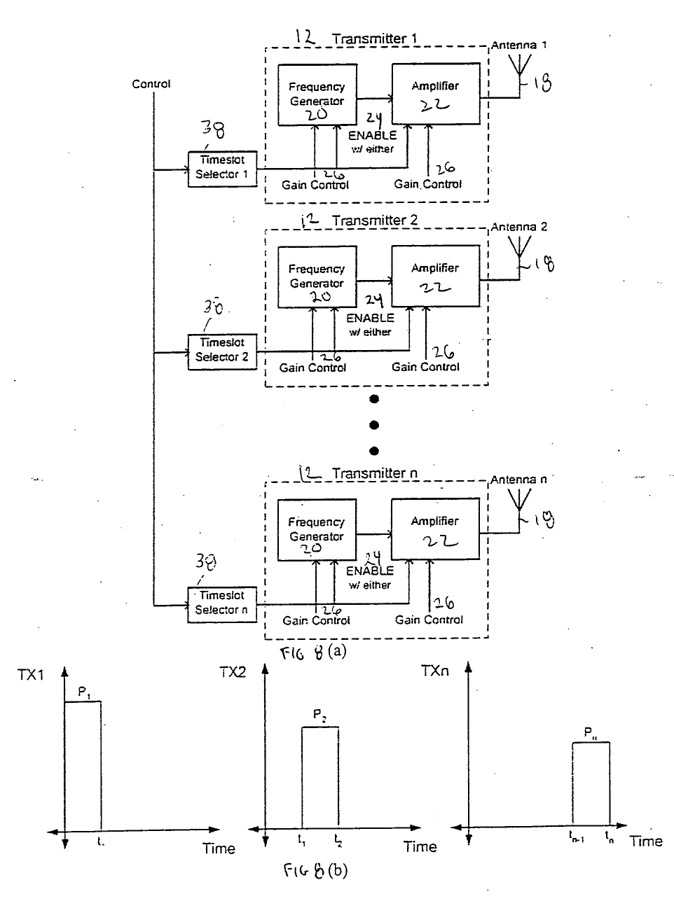

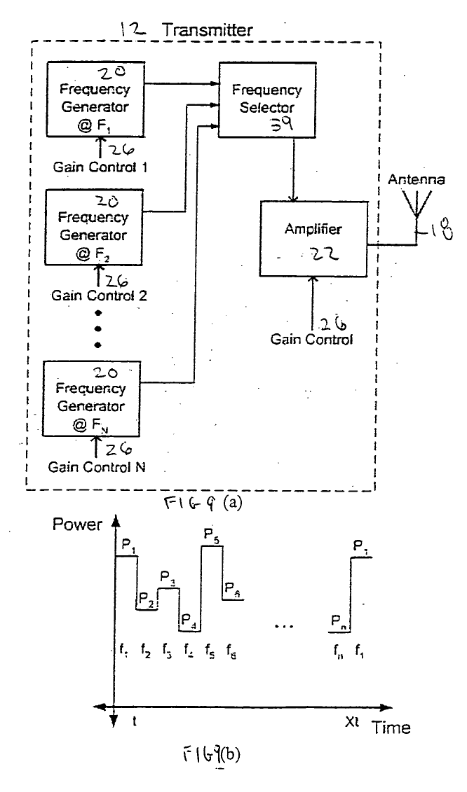

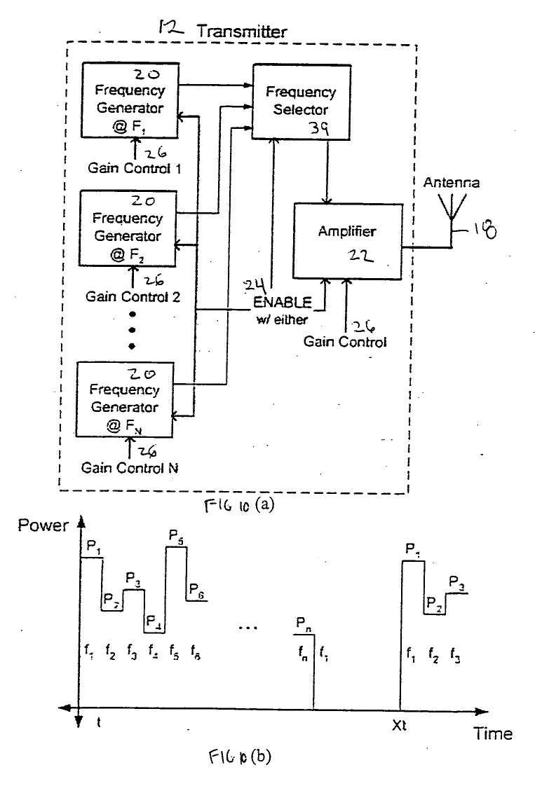

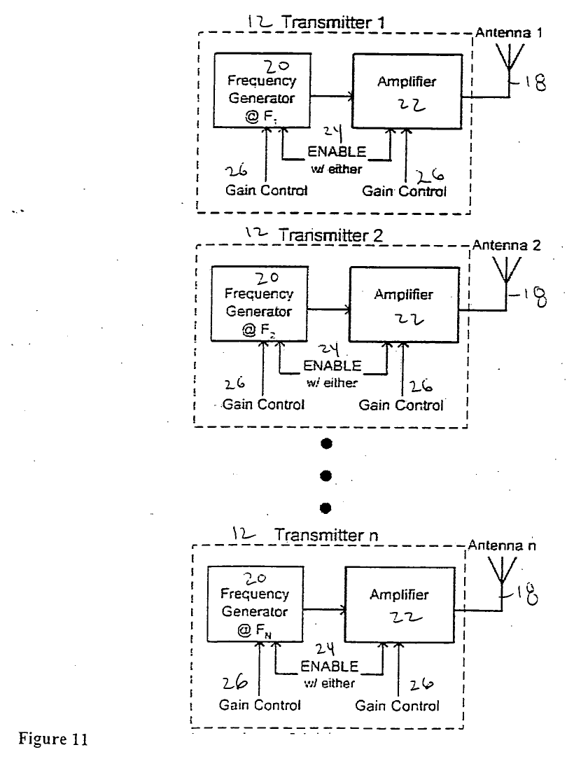

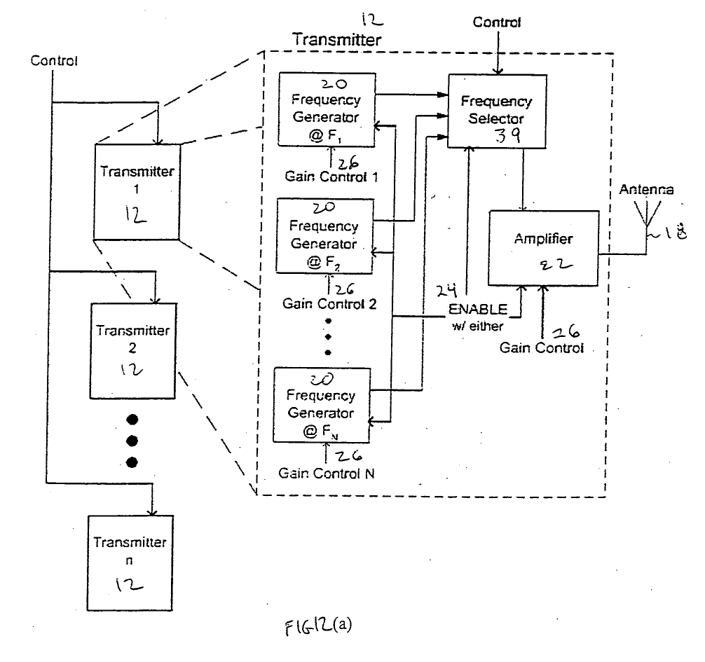

The present invention pertains to a system 10 for power transmission. The system 10 comprises means for transmitting pulses of power, such as shown in FIGS. 2, 4, 5, 6b, 7a, 8a, 9a, 10a, 11, and 12a. The system 10 comprises means for receiving the pulses of power transmitted by the transmitting means to power a load 16 but does not use the pulses for a clock 34 signal, such as shown in FIG. 3a.

The present invention pertains to a transmitter 12 for transmitting power to a receiver 32 to power a load 16, where the receiver 32 does not have a DC-DC converter 36. The transmitter 12 comprises means for producing pulses of power, such as shown in FIGS. 2, 4, 5, 6b, 7a, 8a, 9a, 10, 11, 12a. The transmitter 12 comprises an antenna 18 in communication with the pulse generator 14 through which the pulses are transmitted from the transmitter 12.

Pulse Transmission Method (PTM)—1

In the operation of the invention, current methods of Radio Frequency (RF) power transmission use a Continuous Wave (CW) system. This means the transmitter 12 continuously supplies a fixed amount of power to a remote unit (antenna, rectifier, device). However, the rectifier 28 has an efficiency that is proportional to the power received by the antenna 18. To combat this problem, a new method of power transmission was developed that involves pulsing the transmitted power (On-Off Keying (OOK) the carrier frequency). Pulsing the transmission allows higher peak power levels to obtain an average value equivalent to a CW system. This concept is illustrated in FIGS. 1a-1d. It should be noted that each pulse may have a different amplitude.

As shown in FIG. 1a, the CW system supplies a fixed/average power of P₁. The rectifying circuit, therefore, converts the received power at an efficiency of E₁ as shown in FIG. 1c. The pulsed transmission method, which is shown in FIG. 1b, also has an average power of P₁, however it is not fixed. Instead, the power is pulsed at X times P₁ to obtain an average of P₁. This allows the system to be equivalent to the CW systems when evaluated by regulatory agencies. The main benefit of this method is the increase in the efficiency of the rectifying circuit to E₂. This means the device will see an increase in the power and voltage available even though the average transmitting power remains constant for both systems. The increase in Direct Current (DC) power can be seen in FIG. 1d where E₁ and E₂ correspond to DC₁ and DC₂, respectively. A block diagram representation of this system 10 can be seen in FIG. 2. The receiving circuit can take many different forms. One example of a functional device is given in U.S. Pat. No. 6,615,074 (Apparatus for Energizing a Remote Station and Related Method), incorporated by reference herein.

The pulsing is accomplished by first enabling both the frequency generator 20 and the amplifier 22. Then the enable line, which will be enabled at this point, will be toggled on either the Frequency generator 20 or the Amplifier 22 to disable then re-enable one of the devices. This action will produce the pulsed output. As an example, if the enable line on the Frequency generator 20 is toggled ON and OFF, this would correspond to producing RF energy followed by no RF energy.

To distinguish the PTM from a CW system, it becomes necessary to define the minimum duration between pulses. This time will be a function of the transmitting frequency, and would be limited to one half of one cycle of the output from the frequency generator 20. It would be possible to decrease the OFF time further but switching during a positive or negative swing would produce harmonics that would be delivered to the antenna 18. This would mean frequencies other than the carrier would also be transmitted, leading to possible interference with other frequency bands. However, practically switching at such high rates will not be advantageous. The response times for the Frequency generator 20, Amp, and Rectifier 28 will almost always be longer than the short durations described. This means the system would not be able to respond to changes that quickly, and benefits of the PTM system would be degraded.

Examples of each block are as follows.

TABLE 1
Descriptions for FIG. 2 Blocks

| Block | Examples |
|---|---|
| Frequency | RF Signal Generator (Agilent 8648), Phase-Locked Loop |
| Generator | (PLL), Oscillator |
| Amplifier | Amplifier Research 5W1000, MHL9838 |
| Rectifier | Full-wave, Half-wave, Specialized |
| Filter | Capacitor, L-C |
| Load | Device, Battery, Resistor |

FIG. 3 shows how the pulsed waveform is constructed using the carrier frequency. As can be seen, the pulse simply tells the duration and amplitude of the transmitted frequency. Also illustrated, is a simple equation for determining the average power of the pulsed transmission. The resulting average of the pulsed signal is equivalent to the CW signal.

One example of where this method could be used is in the 890-940 MHz range. The Federal Communications Commission (FCC) lists requirements for operation in this band in Section 15.243 of the Code of Federal Regulations (CFR), Title 47. This specification appears in Appendix A. The regulations for this band specify that the emission limit is measured with an average detector, and peak transmissions are limited by Section 15.35, which appears in Appendix B. This regulation states that the peak emission is limited to 20 dB (100 times) the average power stated for that frequency band. This would correspond to a limit of X=100 in FIG. 1b.

It should be noted that this method works at any frequency. Tests have been performed in the FM radio band at 98 MHz. The tests were performed in a shielded room to avoid interference with radio service. The duty cycle of the pulse was varied from 100 percent (CW) to 1 percent with a constant period of 100 milliseconds (ms) and 1 second, which are shown in Table 2 and Table 3, respectively. The amplitude of the pulse was adjusted to obtain an average power of 1 milliwatt (mW). The tables show the various duty cycles tested, and the DC voltage and power converted by the receiver 32. The receiving circuit is illustrated in FIG. 2. As can be seen from Table 3, the received DC voltage increases by a factor of approximately 10, and the power increases by a factor of approximately 100 by changing the duty cycle from 100% to 1%.

TABLE 2
Experimental Results at 98 MHz, Period of 100 m

| | | Peak | Average | | |
|---|---|---|---|---|---|
| | Pulse | Transmit | Transmit | Received | Received |
| Duty | Width | Power | Power | DC Voltage | DC Power |
| Cycle | (ms) | (mW) | (mW) | (V) | (μW) |
| 100.0% | 100.0 | 1.00 | 1.00 | 0.31 | 0.291 |
| 50.0% | 50.0 | 2.00 | 1.00 | 0.28 | 0.238 |
| 40.0% | 40.0 | 2.50 | 1.00 | 0.46 | 0.641 |
| 20.0% | 20.0 | 5.00 | 1.00 | 0.74 | 1.659 |
| 16.0% | 16.0 | 6.25 | 1.00 | 0.83 | 2.088 |
| 10.0% | 10.0 | 10.0 | 1.00 | 1.09 | 3.600 |
| 8.00% | 8.00 | 12.5 | 1.00 | 1.25 | 4.735 |
| 5.00% | 5.00 | 20.0 | 1.00 | 1.55 | 7.280 |
| 4.00% | 4.00 | 25.0 | 1.00 | 1.72 | 8.965 |
| 2.00% | 2.00 | 50.0 | 1.00 | 2.4 | 17.455 |
| 1.60% | 1.60 | 62.5 | 1.00 | 2.6 | 20.485 |
| 1.25% | 1.25 | 80.0 | 1.00 | 2.71 | 22.255 |
| 1.00% | 1.00 | 100.0 | 1.00 | 2.54 | 19.550 |

TABLE 3
Experimental Results at 98 MHz, Period of 1000 ms

| | | Peak | Average | | |
|---|---|---|---|---|---|
| | Pulse | Transmit | Transmit | Received | Received |
| Duty | Width | Power | Power | DC Voltage | DC Power |
| Cycle | (ms) | (mW) | (mW) | (V) | (μW) |
| 100.0% | 1000.0 | 1.00 | 1.00 | 0.29 | 0.255 |
| 50.0% | 500.0 | 2.00 | 1.00 | 0.41 | 0.509 |
| 40.0% | 400.0 | 2.50 | 1.00 | 0.52 | 0.819 |
| 20.0% | 200.0 | 5.00 | 1.00 | 0.74 | 1.659 |
| 16.0% | 160.0 | 6.25 | 1.00 | 0.85 | 2.189 |
| 10.0% | 100.0 | 10.0 | 1.00 | 1.12 | 3.801 |
| 8.00% | 80.00 | 12.5 | 1.00 | 1.26 | 4.811 |
| 5.00% | 50.00 | 20.0 | 1.00 | 1.6 | 7.758 |
| 4.00% | 40.00 | 25.0 | 1.00 | 1.75 | 9.280 |
| 2.00% | 20.00 | 50.0 | 1.00 | 2.31 | 16.170 |
| 1.60% | 16.00 | 62.5 | 1.00 | 2.61 | 20.643 |
| 1.25% | 12.50 | 80.0 | 1.00 | 2.83 | 24.269 |
| 1.00% | 10.00 | 100.0 | 1.00 | 3.03 | 27.821 |

Another example of frequency bands that may be useful when implementing this method includes the Industrial, Scientific, and Medical Band (ISM). This band was established to regulate industrial, scientific, and medical equipment that emits electromagnetic energy on frequencies within the radio frequency spectrum in order to prevent harmful interference to authorized radio communication services. These bands include the following: 6.78 MHz±15 KHz, 13.56 MHz±7 KHz, 27.12 MHz±163 KHz, 40.68 MHz±20 KHz, 915 MHz±13 MHz, 2450 MHz±50 MHz, 5800 MHz±75 MHz, 24125 MHz±125 MHz, 61.25 GHz±250 MHz, 122.5 GHz±500 MHz, and 245 GHz±1GHz.

The Pulsed Transmission System 10 has numerous advantages. Some of them are listed below.
1. The overall efficiency of the system 10 is increased by an increase in the rectifier 28 efficiency. To help illustrate this statement, the data in Table 3 will be examine. The CW system (100% duty cycle) was able to receive and convert 0.255 uW of power while the 1.00% PTM captured 27.821 uW. This is an increase in efficiency by over 10,000%.
2. Larger output voltages can be obtained when comparing the average to a CW system. This is caused by the increase in rectifier 28 efficiency. It is also a factor of the large power pulse, which produces a large voltage pulse at the in input to the filter 30 in FIG. 2. The large voltage pulse will be filtered and provide a larger voltage assuming the load 16 is large.
3. The increase in system efficiency allows the use of less average transmitted power to obtain the same received DC power. This leads to the following advantages.
   a. The human safety distance (Human Safety Distance is a term used to describe how far a person must be from a transmitting source to ensure they are not exposed to RF field strengths higher than that allowed by the FCC's human safety regulations. As an example, the permitted field strength for general population exposure at 915 MHz is 0.61 mW/cm²) from the transmitter is reduced due to the reduction in the average transmitted power.
   b. Less average transmitter power allows operation in an increasing number of bands including those that do not require a license such as the Industrial, Scientific, and Medical (ISM) bands.
   c. For licensed bands, the decrease in the average transmitter power translated to a decrease in the amount of licensed power.

There are current patents that bear a resemblance to the method described, however, their fundamental approach to the problem is for a different purpose. U.S. Pat. No. 6,664,770, incorporated by reference herein, describes a system that uses a pulse modulated carrier frequency to power a remote device that contains a DC to DC (DC-DC) converter. A DC-DC converter is used to transform the level of the input DC voltage up or down depending on the topology chosen. In this case, a boost converter is used to increase the input voltage. The device derives its power from the incoming field and also uses the modulation contained within the signal to switch a transistor (fundamental component in a DC-DC converter) for the purpose of increasing the received voltage. The waveform described within this document will have similar characteristics to the one described in the referenced patent. The system described here has numerous differences. The proposed receiver 32 does not contain a DC-DC converter. In fact, this method was developed for the purpose of increasing the received DC voltage without the need for a DC-DC converter. Also, the modulation contain within the proposed signal is not intended for use as a clock 34 to drive a switching transistor. Its purpose is to allow the use of a large peak power to increase the efficiency of the rectifying circuit, which in turn increases the receiver 32 output voltage without a need for a DC-DC converter or derivation of a clock 34 from the incoming pulsed signal.

As previously stated, the pulsed waveform is not intended for use as a clock 34 signal. If a DC-DC converter is needed in the receiving circuit because the pulsed waveform has not solely produced a large enough voltage increase (by the increase in efficiency), the DC-DC converter will be implemented using an on-board clock 34 generated using the pure DC output of the rectifier 28. The generation of the clock 34 in the receiver 32 proves to be more efficient than including extra circuitry to derive the clock 34 from the incoming pulsing waveform, hence providing a greater receiver 32 efficiency than the referenced patent. FIG. 3a shows how this system would be implemented.

There have recently been successful tests performed by Lucent Digital Radio, Inc., a venture of Lucent Technologies and Pequot Capital Management, Inc., to integrate digital radio service into the existing analog radio signals without interactions with the current service. With this being said, it is possible to integrate a power transmission signal, such as the one described in this document, into existing RF facilities (Radio, TV, Cellular, etc.) if it is found to be advantageous. This would allow the stations to provide content along with power to devices within a specified area.

Pulse Transmission Method—2

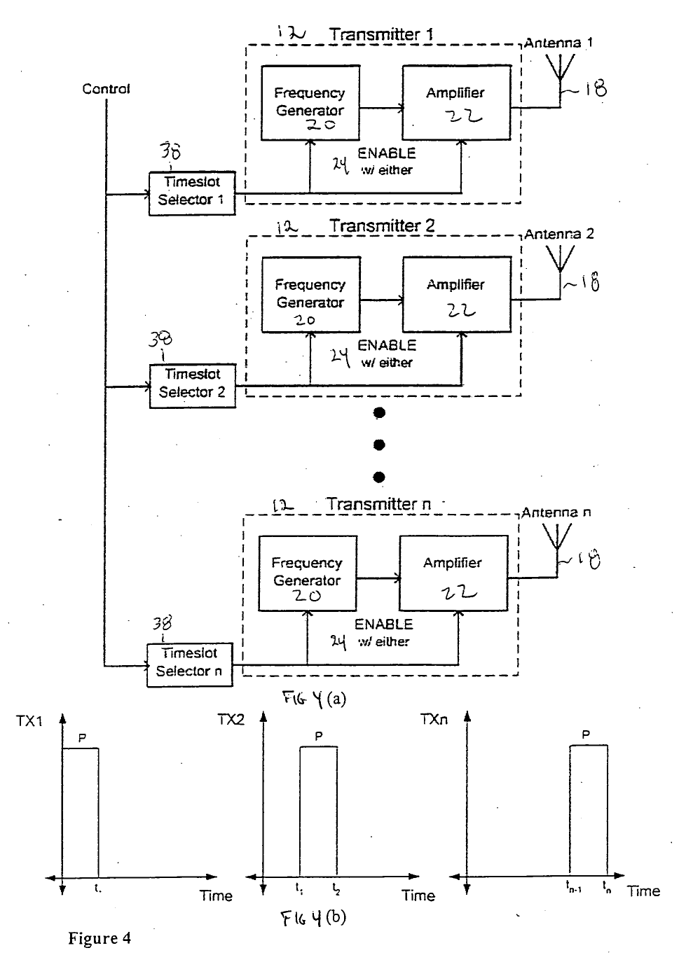

When multiple transmitters 12 are used, the pulse transmission method provides a solution to another common problem, phase cancellation. This is caused when two (or more) waves interact with one another. If one wave becomes 180 degrees out of phase with respect to the other, the opposite phases will cancel and little or no power will be available and that area will be a null. The pulse transmission method alleviates this problem due to its non-CW characteristics. This allows multiple transmitters 12 to be used at the same time without cancellation by assigning each transmitter 12 a timeslot so that only one pulse is active at a given time. For a low number of transmitters 12, timeslots may not be needed due to the low probability of pulse collisions. The system 10 hardware is shown in FIG. 4a while the signals are shown in FIG. 4b. The control signal is used to activate each transmitter 12 for its assigned timeslot. The timeslot selector 38 either enables or disables the transmitting block by providing a signal to the frequency generator 20 and/or the amplifier 22 and can be implemented in numerous ways including a microcontroller.

Pulse Transmission Method—3

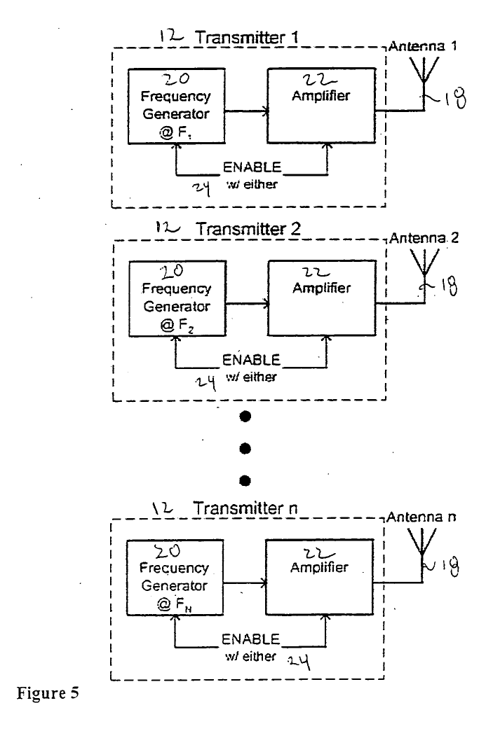

An extension on Method 2 eliminates the need for assigning timeslots. In this method, multiple channels (frequencies) are used to remove the interaction between transmitters 12. The use of multiple channels allows the transmitters 12 to operate concurrently while close channel spacing allows reception of all frequencies by the receiving antenna 18 and rectifier 28. This system 10 is shown in FIG. 5 where each frequency generator 20 is set to a different frequency. All blocks were described in Table 1.

Pulse Transmission Method—Alternatives

There are numerous extensions of the three methods previously described in this document. They include the following.
Alt 1. Method 1—The carrier does not fully go to zero, yet keeps finite values for supplying low power states such as the device's sleep mode. This method is shown in FIG. 6. The blocks have been described in Table 1. The Enable signal line has been replaced with a Gain control 26 line, which is used to adjust the level of the output signal. The Gain control 26 line can be implemented in numerous ways. On the Frequency generator 20, the Gain control 26 line can be a serial input to a Phase-Locked Loop (PLL) used to program internal registers that have numerous responsibilities including adjusting the output power of the device. The Gain control 26 on the Amplifier 22 can simply be a resistive divider used to adjust the gate voltage on the amplifier 22, which in turn changes the amplifier 22 gain. It should be noted that the Gain control 26 line can adjust the amplifier 22 to have both positive and negative gain. This applies to all references to the Gain control 26 line within this document.
Alt 2. Method 1—The transmitter 12 may pulse different frequencies sequentially to reduce the average power for that channel. Each frequency and/or pulse may have different amplitudes. In this block diagram, each Frequency generator 20 produces a different frequency. All of these frequencies are fed into the Frequency selector 39 which determines and routes the correct frequency to the amplifier 22. This block could be implemented with a microcontroller and a coaxial switch. The microcontroller would be programmed with an algorithm that would activate the correct coaxial switch in the appropriate timeslot to produce the waveform in FIG. 7b.
Alt 3. Method 2—Each transmitter 12 and/or frequency may have different amplitudes. This block diagram adds a Gain control 26 to produce various output signal levels.
Alt 4. Method 3—A single transmitter 12 could be used to transmit all the channel frequencies sequentially to eliminate the need for multiple transmitting units. This would resemble a CW system employing frequency hoping although no data will be sent, and the purpose will be for power harvesting. Each channel may have different amplitude. All of these frequencies are fed into the Frequency selector 39 which determines and routes the correct frequency to the amplifier 22. This block could be implemented with a microcontroller and a coaxial switch. The Enable has been removed due to the continuous nature of the output signal.
Alt 5. Alt 4—This waveform (multiple frequencies) could be pulsed as described in Method 1. The single frequency, constant amplitude pulse in Method 1 has been replaced with a pulse containing timeslots. Each timeslot can have a different frequency and amplitude. The Enable line has been added to allow the system to turn the output on and off for pulsing. The Gain control 26 line, Enable line and Frequency selector 39 function as previously described.
Alt 6. Method 3—Each transmitter 12 and/or frequency may have different amplitudes. A Gain control 26 line has been added to allow the output signal level to be varied.
Alt 7. Alt 4—Multiple transmitters 12 could transmit all the channel frequencies sequentially with each channel occurring at a different transmitter 12 in a different timeslot. In this method, a Control signal is used to synchronize multiple transmitters 12 at multiple frequencies in a way that each transmitter 12 is always on a different channel with respect to the other transmitters. This system also includes a gain control 26 to change the level of the output of each transmitter 12. The Control line could be driven by a microcontroller that has been programmed with an algorithm for the purpose of assigning each transmitter 12 a different frequency for the current timeslot. In the next timeslot, the microcontroller would change the frequency assignments while assuring that all transmitters are operating on separate channels. The Gain control 26 of each transmitter 12 could be controlled by the same master microcontroller or by a microcontroller local to that transmitter 12. The Enable Line allows a transmitter 12 to disable itself if found to be beneficial.
   Additional Notes

It should be noted that the pulse widths and periods of sequential pulses may vary with time. Also, the duration of each timeslot may be different and may vary with time.

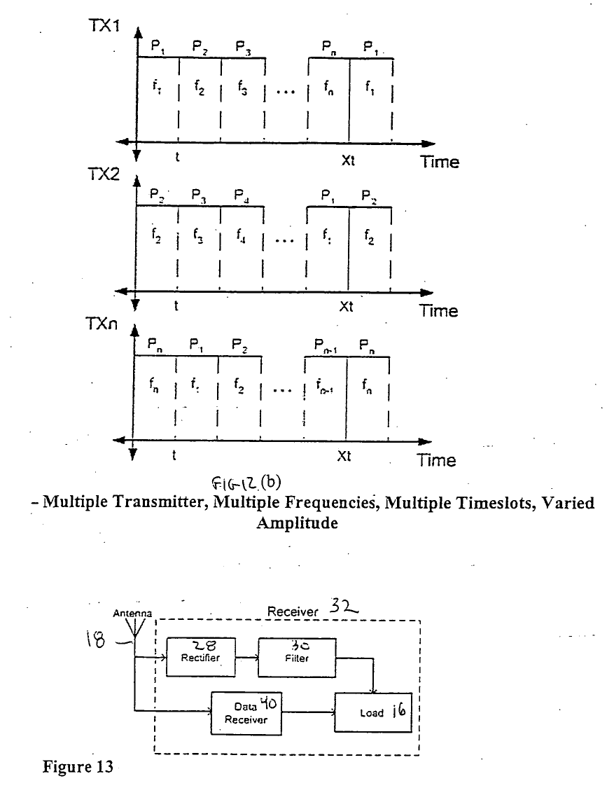

Data could be included within the pulses for communications purposes. This would be accomplished by the inclusion of a data line(s) into the Frequency Generator(s) depicted in the previous figures. This line would be used to modulate the carrier frequency. The receiver 32 would contain an addition apparatus to extract the data from the incoming signal. This is shown in FIG. 13.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

### Appendix A

Section

[Code of Federal Regulations]

[Title 47, Volume 1]

[Revised as of Oct. 1, 2003]

From the U.S. Government Printing Office via GPO Access

[CITE: 47CFR15.243]

[Page 750]

### Title 47—Telecommunication

### Chapter I—Federal Communications Commission

Part 15—Radio Frequency Devices—Table of Contents

### Subpart C—Intentional Radiators

Sec. 15.243 Operation in the band 890-940 MHz.

(a) Operation under the provisions of this section is restricted to devices that use radio frequency energy to measure the characteristics of a material. Devices operated pursuant to the provisions of this section shall not be used for voice communications or the transmission of any other type of message.

(b) The field strength of any emissions radiated within the specified frequency band shall not exceed 500 microvolts/meter at 30 meters. The emission limit in this paragraph is based on measurement instrumentation employing an average detector. The provisions in Sec. 15.35 for limiting peak emissions apply.

(c) The field strength of emissions radiated on any frequency outside of the specified band shall not exceed the general radiated emission limits in Sec. 15.209.

(d) The device shall be self-contained with no external or readily accessible controls which may be adjusted to permit operation in a manner inconsistent with the provisions in this section. Any antenna that may be used with the device shall be permanently attached thereto and shall not be readily modifiable by the user.

[[Page 751]]

### Appendix B

Section

[Code of Federal Regulations]

[Title 47, Volume 1]

[Revised as of Oct. 1, 2003]

From the U.S. Government Printing Office via GPO Access

[CITE: 47CFR15.35]

[Page 701-702]

### Title 47—Telecommunication

### Chapter I—Federal Communications Commission

Part 15—Radio Frequency Devices—Table of Contents

### Subpart A—General

Sec. 15.35 Measurement detector functions and bandwidths.

The conducted and radiated emission limits shown in this part are based on the following, unless otherwise specified elsewhere in this part:

(a) On any frequency or frequencies below or equal to 1000 MHz, the limits shown are based on measuring equipment employing a CISPR quasi-peak detector function and related measurement bandwidths, unless otherwise specified. The specifications for the measuring instrument using the CISPR quasi-peak detector can be found in Publication 16 of the International Special Committee on Radio Interference (CISPR) of the International Electrotechnical Commission. As an alternative to CISPR quasi-peak measurements, the responsible party, at its option, may demonstrate compliance with the emission limits using measuring equipment employing a peak detector function, properly adjusted for such factors as pulse desensitization,

[[Page 702]]

as long as the same bandwidths as indicated for CISPR quasi-peak measurements are employed.

Note: For pulse modulated devices with a pulse-repetition frequency of 20 Hz or less and for which CISPR quasi-peak measurements are specified, compliance with the regulations shall be demonstrated using measuring equipment employing a peak detector function, properly adjusted for such factors as pulse desensitization, using the same measurement bandwidths that are indicated for CISPR quasi-peak measurements.

(b) Unless otherwise stated, on any frequency or frequencies above 1000 MHz the radiated limits shown are based upon the use of measurement instrumentation employing an average detector function. When average radiated emission measurements are specified in this part, including emission measurements below 1000 MHz, there also is a limit on the radio frequency emissions, as measured using instrumentation with a peak detector function, corresponding to 20 dB above the maximum permitted average limit for the frequency being investigated unless a different peak emission limit is otherwise specified in the rules, e.g., see Secs. 15.255, 15.509 and 15.511. Unless otherwise specified, measurements above 1000 MHz shall be performed using a minimum resolution bandwidth of 1 MHz. Measurements of AC power line conducted emissions are performed using a CISPR quasi-peak detector, even for devices for which average radiated emission measurements are specified.

(c) Unless otherwise specified, e.g. Sec. 15.255(b), when the radiated emission limits are expressed in terms of the average value of the emission, and pulsed operation is employed, the measurement field strength shall be determined by averaging over one complete pulse train, including blanking intervals, as long as the pulse train does not exceed 0.1 seconds. As an alternative (provided the transmitter operates for longer than 0.1 seconds) or in cases where the pulse train exceeds 0.1 seconds, the measured field strength shall be determined from the average absolute voltage during a 0.1 second interval during which the field strength is at its maximum value. The exact method of calculating the average field strength shall be submitted with any application for certification or shall be retained in the measurement data file for equipment subject to notification or verification.

[54 FR 17714, Apr. 25, 1989, as amended at 56 FR 13083, Mar. 29, 1991; 61 FR 14502, Apr. 2, 1996; 63 FR 42279, Aug. 7, 1998; 67 FR 34855, May 16, 2002]

What is claimed is:

1. A transmitter for transmitting power to a receiver to power a load, where the receiver does not have a DC-DC converter, comprising:
a pulse generator for producing pulses of power; and
an antenna in communication with the pulse generator through which the pulses are transmitted from the transmitter.

2. A transmitter as described in claim 1 wherein the pulse generator includes a frequency generator having an output, and an amplifier in communication with the frequency generator and the antenna.

3. A transmitter as described in claim 2 including an enabler which controls the frequency generator or the amplifier to form the pulses.

4. A transmitter as described in claim 3 wherein the enabler defines a time duration between pulses as a function of a transmitting frequency of the pulses.

5. A transmitter as described in claim 4 wherein the time duration is greater than one-half of one cycle of the frequency generator output.

6. The transmitter as described in claim 5 wherein the power of the transmitted pulses is equivalent to an average power of a continuous wave power transmission system.

7. A transmitter as described in claim 6 wherein the average power Pavg of the pulses is determined by
$${P}_{AVG} = \frac{{P}_{PEAK} ( {T}_{PULSE} )}{{T}_{PERIOD}} .$$

8. A transmitter as described in claim 7 wherein the pulses are transmitted in any ISM band.

9. A transmitter as described in claim 7 wherein the pulses are transmitted in an FM radio band.

10. A transmitter as described in claim 1 wherein the pulse generator produces a continuous amount of power between pulses.

11. A transmitter as described in claim 1 wherein the pulse generator produces pulses at different output frequencies sequentially.

12. A transmitter as described in claim 1 wherein the pulse generator produces pulses at different amplitudes.

13. A transmitter as described in claim 12 wherein the pulse generator includes a plurality of frequency generators; an amplifier; and a frequency selector in communication with the frequency generators and the amplifier, that determines and routes the correct frequency from the frequency generators to the amplifier.

14. A transmitter as described in claim 1 wherein the pulse generator transmits data between the pulses.

15. A transmitter as described in claim 1 wherein the pulse generator transmits data in the pulses.

16. A transmitter as described in claim 2 including a gain control which controls the frequency generator or the amplifier to form the pulses.

17. A transmitter as described in claim 16 wherein the gain control defines a time duration between pulses as a function of a transmitting frequency of the pulses.

18. A system for power transmission comprising:
a transmitter which transmits only pulses of power without any data; and
a receiver which receives the pulses of power transmitted by the power transmitter to power a load.

19. A system as described in claim 18 wherein the receiver includes a rectifier.

20. A system as described in claim 19 wherein the rectifier efficiency is increased by over 5 percent as compared to a corresponding continuous wave power transmission system by receiving the pulses of power.

21. A system as described in claim 20 wherein the rectifier efficiency is increased by over 100 percent as compared to a corresponding continuous wave power transmission system.

22. A method for transmitting power to a receiver to power a load comprising the steps of:
producing pulses of power with a pulse generator; and
transmitting the pulses through an antenna in communication with the pulse generator to the receiver to power the load.

23. A method for transmitting power comprising the steps of:
transmitting pulses of power with a transmitter; and
receiving the pulses of power transmitted by the power transmitter with a receiver to power a load, the receiver has a rectifier whose efficiency is increased as compared to a corresponding continuous wave power transmission system by receiving the pulses of power.

24. An apparatus for transmitting power to a receiver to power a load comprising:
a plurality of transmitters, each of which produce pulses of power which are received by the receiver to power the load.

25. An apparatus as described in claim 24 including a controller in communication with each transmitter, each transmitter is assigned an associated time slot by the controller so that only one pulse from the plurality of transmitters is transmitted at a given time.

26. An apparatus as described in claim 25 including a plurality of time slot selectors, each transmitter in communication with a corresponding time slot selector of the plurality of time slot selectors, the controller issues a control signal to each selector which activates the corresponding transmitter for its assigned time slot.

27. A method for transmitting power to a receiver to power a load comprising:
producing pulses of power from an apparatus having a plurality of transmitters which are received by the receiver to power the load.

28. A system for power transmission comprising:
a transmitter which transmits pulses of power; and
a receiver which receives the pulses of power transmitted by the power transmitter to power a load but does not use the pulses as a clock signal.

29. A system for power transmission comprising:
means for transmitting pulses of power; and
means for receiving the pulses of power transmitted by the transmitting means to power a load but does not use the pulses for a clock signal.

30. A system for power transmission comprising:
means for transmitting only pulses of power without any data; and
means for receiving the pulses of power transmitted by the transmitting means to power a load.

31. A transmitter for transmitting power to a receiver to power a load, where the receiver does not have a DC-DC converter, comprising:
means for producing pulses of power; and
an antenna in communication with the pulsing means through which the pulses are transmitted from the transmitter.

32. An apparatus for transmitting power to a receiver to power a load comprising:
a transmitter which produces only pulses of power without any data; and
an antenna in communication with the transmitter through which the pulses are transmitted from the transmitter.
